(19) United States
(12) Patent Application Publication
(10) Pub. No.: US 2018/0356649 A1
(43) Pub. Date: Dec. 13, 2018

(54) TELESCOPING EARPIECE FOR EYEGLASSES

(71) Applicant: VisOptical, LLC, Fenton, MO (US)

(72) Inventor: David R. Porter, St. Louis, MO (US)

(21) Appl. No.: 15/616,379

(22) Filed: Jun. 7, 2017

(51) Int. Cl. G02C 5/20

(52) U.S. Cl. CPC G02C 5/20

(57) ABSTRACT

An eyeglass apparatus includes a pair of lenses, a frame coupled to the pair of lenses, and a pair of earpieces coupled to the frame. Each earpiece includes a temple portion coupled to the frame and defining a cavity. Each earpiece also includes an ear portion slidably coupled to the temple portion between an extended portion and a collapsed position. At least a portion of the ear portion is positioned within the cavity when the ear portion is in the collapsed position.

### BACKGROUND

This disclosure relates generally to eyeglasses, and more particularly, to telescoping earpieces for use with a pair of eyeglasses.

Conventional eyeglasses generally include a frame, two lenses, and two ear pieces that fold at a hinge where the frame meets the ear pieces. Such eyeglasses are relatively bulky and may become damaged when stored in a pocket or a bag. At least some known eyeglasses include ear pieces that have a hinge in the middle to allow each ear piece to fold on itself. While such a configuration reduces the size of stored eyeglasses compared to conventional configurations, at least some such eyeglasses include ear pieces that are curved to conform to the shape of the wearers head. Such curvature results in space inefficiencies for some eyeglasses when the eyeglasses are stored. Furthermore, some known eyeglasses include a sliding mechanism to allow one portion of the ear piece to slide with respect to another portion of the ear piece. However, in at least some such configurations, the two ear piece portions are required to be offset from one another, rather than being axially aligned. Such an offset may also result in an inefficient storage configuration.

### BRIEF DESCRIPTION

In one aspect, an eyeglass apparatus is provided. The eyeglass apparatus includes a pair of lenses, a frame coupled to the pair of lenses, and a pair of earpieces coupled to the frame. Each earpiece includes a temple portion coupled to the frame and defining a cavity. Each earpiece also includes an ear portion slidably coupled to the temple portion between an extended portion and a collapsed position. At least a portion of the ear portion is positioned within the cavity when the ear portion is in the collapsed position.

In another aspect, an eyeglass apparatus is provided. The eyeglass apparatus includes a pair of lenses, a frame coupled to the pair of lenses, and a pair of earpieces coupled to the frame. Each earpiece includes a temple portion coupled to the frame, a latch pivotally coupled to the temple portion, and an ear portion slidably coupled to the temple portion between an extended position and a collapsed position. The latch is selectively coupled to the ear portion to enable movement of the ear portion between the extended position and the collapsed position.

### BRIEF DESCRIPTION OF THE DRAWINGS

FIG. 1 is a perspective view of an exemplary eyeglass apparatus.

FIG. 2 is a side view of an exemplary temple portion of an ear piece for use with the eyeglass apparatus shown in FIG. 1.

FIG. 2A is a cross-sectional view of a first portion of the temple portion shown in FIG. 2.

FIG. 2B is a cross-sectional view of a second portion of the temple portion shown in FIG. 2.

FIG. 3 is a side view of an exemplary ear portion of an ear piece for use with the eyeglass apparatus shown in FIG. 1.

FIG. 3A is a cross-sectional view of the ear portion shown in FIG. 3.

FIG. 4 is a perspective view of a latch that may be used with the eyeglass apparatus shown in FIG. 1.

FIG. 5 is a side view of an exemplary ear piece with the ear portion in an extended position.

FIG. 6 is a side view of the ear piece with the ear portion in transition from the extended position.

FIG. 7 is a side view of the ear piece with the ear portion in a collapsed position.

### DETAILED DESCRIPTION

The above-described embodiments of an eyeglass apparatus provide a telescopic ear piece that facilitates reducing the space required to store the eyeglass apparatus. Specifically, the eyeglass apparatus includes a pair of lenses, a frame coupled to the pair of lenses, and a pair of earpieces coupled to the frame. Each earpiece includes a temple portion coupled to the frame, a latch pivotally coupled to the temple portion, and an ear portion slidably coupled to the temple portion between an extended position and a collapsed position. The latch is selectively coupled to one of the ear portion and the temple portion to enable movement of the ear portion between the extended position and the collapsed position. Furthermore, the temple portion houses at least a portion of the ear portion when the ear portion is in the collapsed position. Moreover, a portion of the temple portion is U-shaped to enable telescopic engagement of the temple portion and the ear portion.

By housing the majority of the ear portion within the temple portion in the collapsed position, the eyeglass apparatus requires a smaller volume of space in which to store the eyeglasses than convention eyeglasses. The telescopic configuration makes efficient use of the space within the temple portion to provide for a compact storage configuration of the eyeglasses. Furthermore, because the ear portion is stored within the temple portion, the ear piece provides a structure that is more durable and less likely to be damaged when stored.

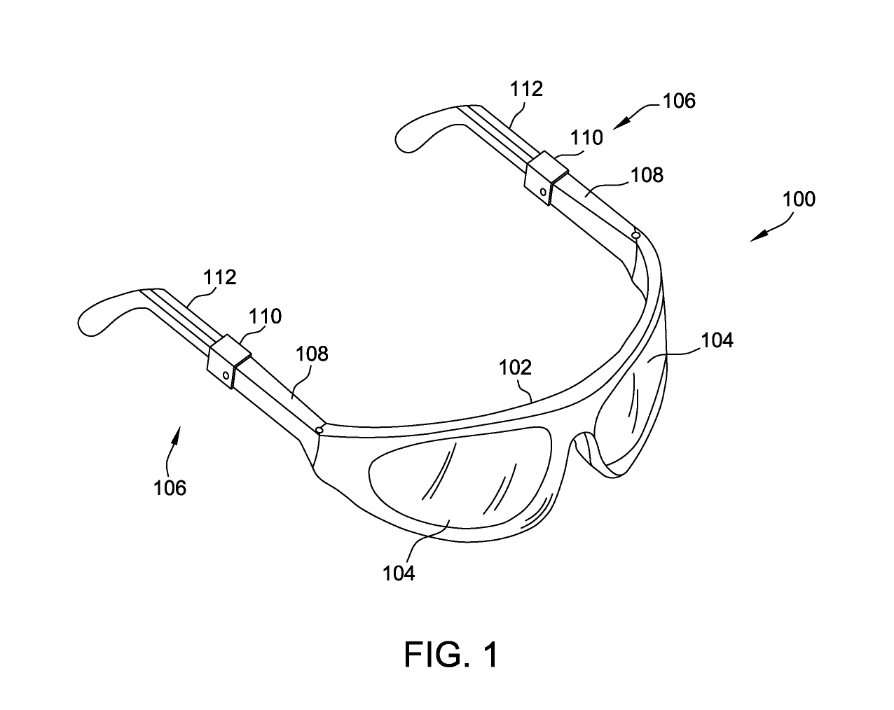

Referring to the drawings, FIG. 1 is a perspective view of an exemplary eyeglass apparatus 100 that includes a frame 102, a pair of lenses 104 coupled to frame 102, and a pair of ear pieces 106 coupled to frame 102. In the exemplary embodiment, each ear piece 106 includes a temple portion 108 pivotally coupled to frame 102, a latch 110 pivotally coupled to temple portion 108, and an ear portion 112 slidably coupled to temple portion 108 between an extended position and a collapsed position. FIG. 1 illustrates ear portion 112 in the extended position, allowing apparatus 100 to be worn by a user.

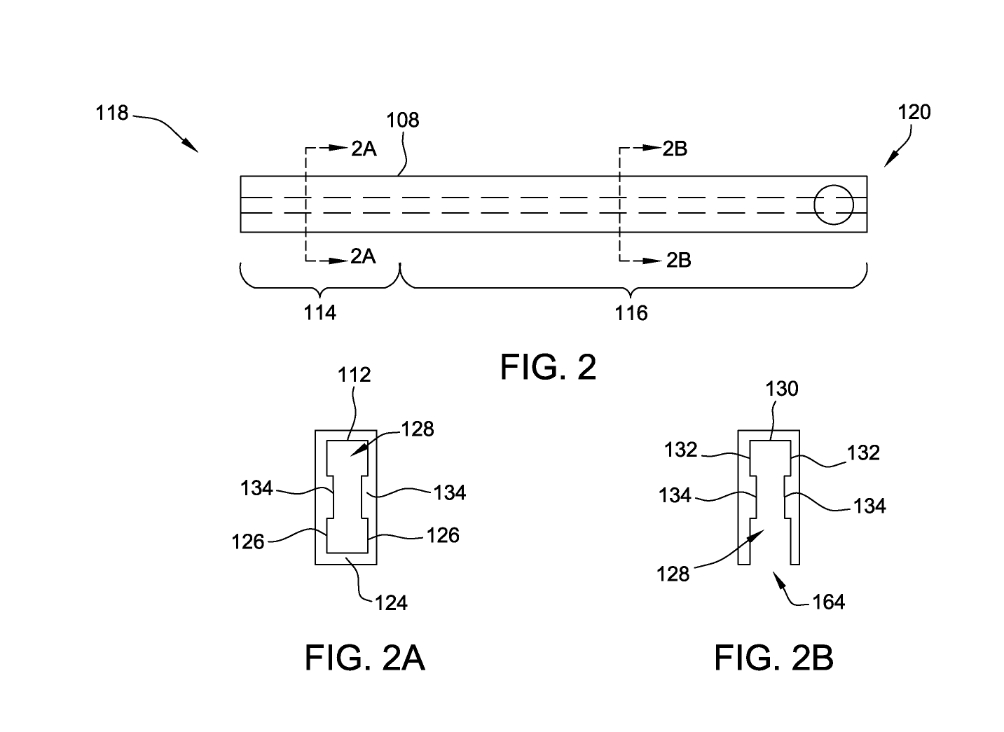

FIG. 2 is a side view of temple portion 108 of ear piece 106 (shown in FIG. 1) for use with eyeglass apparatus 100 (shown in FIG. 1). FIG. 2A is a cross-sectional view of a first portion 114 of temple portion 108, and FIG. 2B is a cross-sectional view of a second portion 116 of temple portion 116. First portion 114 includes a first end 118 of temple portion 108 and is coupled to frame 102 (shown in FIG. 1). Second portion 116 includes a second end 120 of temple portion 108 and is coupled to latch 110 and ear portion 112.

As shown in FIG. 2A, first portion 114 of temple portion 108 includes a top wall 122, a bottom wall 124, and a pair of opposing sidewalls 126 that combine to define a cavity 128 within temple portion 108. In the exemplary embodiment, first portion 114 includes four walls 122, 124, and 126 that completely enclose cavity 128. Similarly, as shown in FIG. 2B, second portion 116 of temple portion 108 includes a top wall 130 and a pair of opposing sidewalls 132 that combine to define cavity 128 within temple portion 108. In the exemplary embodiment, second portion 116 includes only three walls 130 and 132 such that second portion 116 does not include a bottom wall and is substantially U-shaped. The open-bottomed configuration of temple portion second portion 116 enables movement of ear portion 112 between the extended position and the collapsed position, as described herein.

In the exemplary embodiment, temple portion also includes a pair of guides 134 extending into cavity 128 from sidewalls 126 and 132. Guides 134 are configured to engage ear portion 112 to facilitate telescopic movement of ear portion 112 between the extended position and the collapsed position, as described in further detail below. Although temple portion 108 is shown as having two guides 134 that each extend a full distance between ends 118 and 120, temple portion 108 may include only one guide 134 that extends any length of temple portion 108 between ends 118 and 120 to facilitate operation of eyeglass apparatus 10 as described herein.

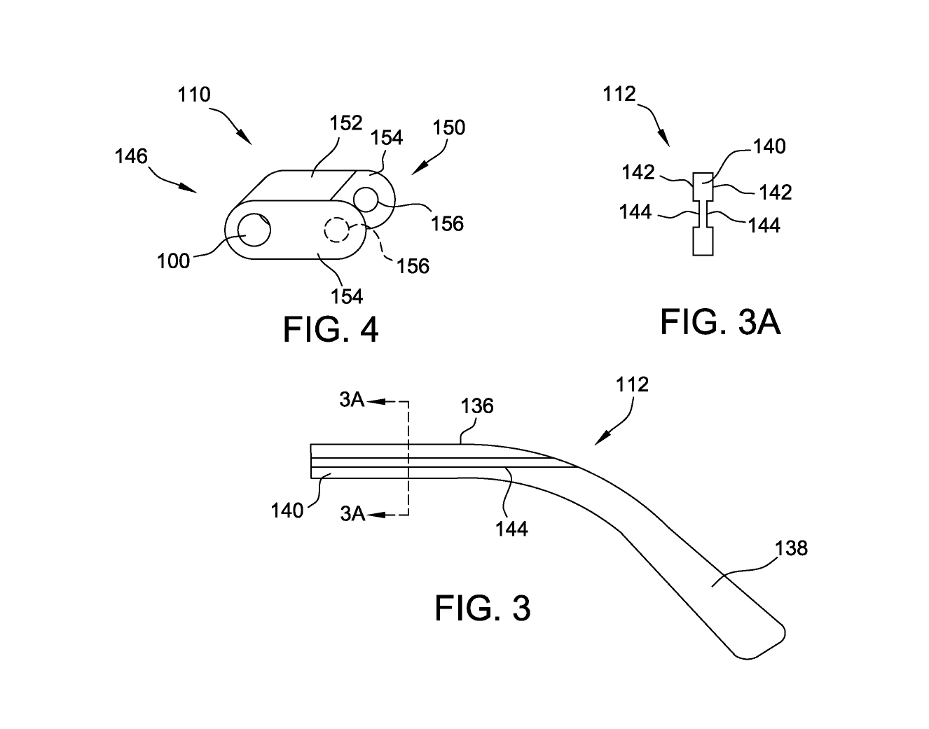

FIG. 3 is a side view of ear portion 112 of ear piece 106 (shown in FIG. 1) for use with eyeglass apparatus 100 (shown in FIG. 1), and FIG. 3A is a cross-sectional view of ear portion 112. In the exemplary embodiment, ear portion 112 includes an extension portion 136 and a hook portion 138. Hook portion 138 is configured to curve around a user's ear to hold eyeglass apparatus 100 in place during use. Extension portion 136 is slidably and telescopically coupled to temple portion 108 and is selectively coupled to latch 110. More specifically, as shown in FIG. 3A, extension portion 136 includes a body 140 including a pair of sidewalls 142 that each include a groove 144 defined therein. In the exemplary embodiment, body 140 is configured for insertion into cavity 128 of temple portion 108 such that guides 134 on temple portion 108 slidably engage grooves 144 on ear portion 112 to enable telescopic movement of ear portion 112 with respect to temple portion 108 between the extended position and the collapsed position.

FIG. 4 is a perspective view of latch 110 that may be used with eyeglass apparatus 100 (shown in FIG. 1). In the exemplary embodiment, latch 110 includes a first end 146 pivotally coupled to second end 120 of temple portion 108 at a pivot point 148 and a second end 150 selectively coupled to ear portion 112. Latch 110 also includes a top wall 152 and a pair of sidewalls 154 extending therefrom such that latch 110 is substantially U-shaped in cross-section. Each sidewall 154 includes a projection 156 extending inward towards the opposing sidewall. In the exemplary embodiment, projections 156 are configured to selectively engage grooves 144 of ear portion 112 to enable telescopic movement of ear portion 112 with respect to temple portion 108 between the extended position and the collapsed position, as described in further detail below.

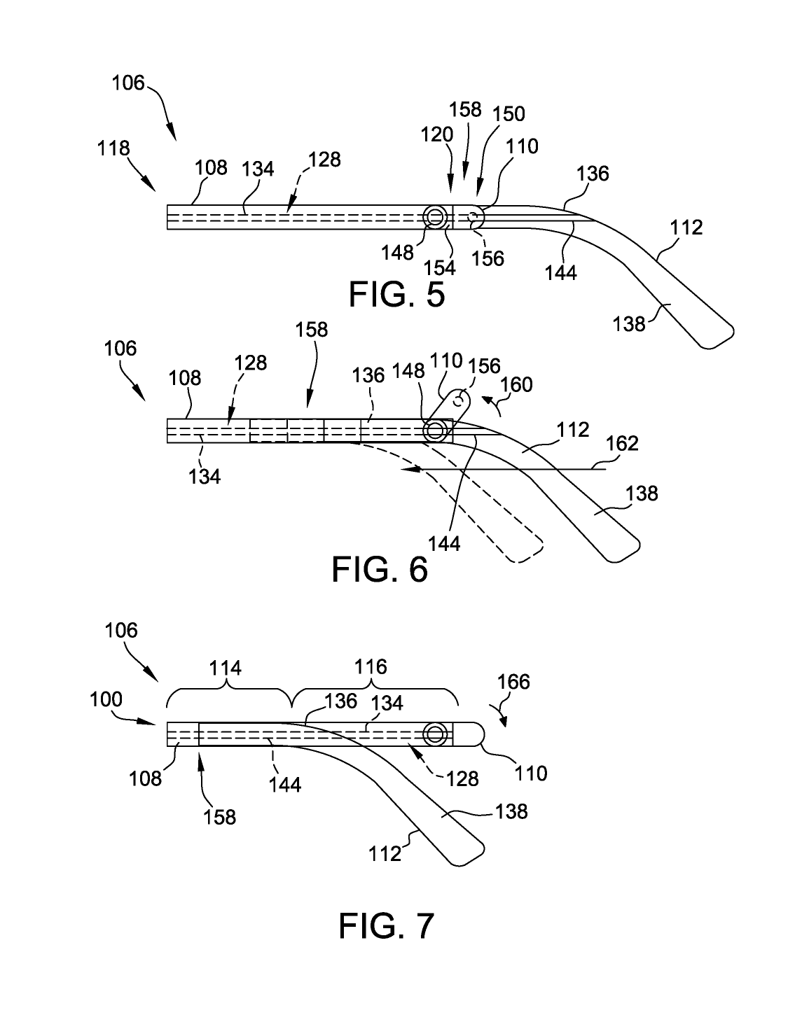

FIG. 5 is a side view of an exemplary ear piece 106 with ear portion 112 in an extended position, FIG. 6 is a side view of ear piece 106 with ear portion 112 in an intermediate position, and FIG. 7 is a side view of ear piece 106 with ear portion 112 in the collapsed position. In the exemplary embodiment, a user may elect to wear eyeglass apparatus 100 in the extended position and store eyeglass apparatus 100 in the collapsed position. Furthermore, a user may also wear eyeglass apparatus 100 in any intermediate position between the extended and collapsed positions that best fits the user's head size.

In the exemplary embodiment, when ear piece 106 is in the extended position, as shown in FIG. 5, latch 110 is aligned with temple portion 108 and ear portion 112 such that ear portion 112, and more specifically, extension portion 136, is positioned between sidewalls 154 of latch 110. Furthermore, in the extended position, projections 156 on sidewalls 154 of latch 110 engage grooves 144 on extension portion 136 of ear portion 112. When latch 110 is engaged with ear portion, more specifically, when projections 156 are engaged with grooves 144, ear portion 112 is prevented from moving axially with respect to latch 110 and temple portion 108. In the exemplary embodiment, in the extended position, grooves 144 at a first end 158 of ear portion 112 are engaged with guides 134 of second portion 116 at second end 120 of temple portion 108 such that a portion of ear portion 112 is positioned within cavity 128 in the extended position. Alternatively, in the extended position, ear portion 112 is spaced away from temple portion 108 within latch 110 such that ear portion 112 is not positioned within cavity 128 in the extended position.

FIG. 6 illustrates ear portion 112 moving from the extended position toward the collapsed position. In operation, to enable movement of ear portion 112 between the extended position and the collapsed position, latch 110 is rotated about pivot point 148 in the direction of arrow 160 such that projections 156 disengage grooves 144 of ear portion 112. As such, latch 110 is selectively coupled to ear portion 112 based on a desired configuration of ear piece 106 to enable movement of ear portion 112 between the extended position and the collapsed position. In the exemplary embodiment, grooves 144 at a first end 158 of ear portion 112 are engaged with guides 134 at second end 120 of temple portion 108 such that when latch 110 is disengaged from ear portion 112, ear portion 112 is able to be slid along temple portion 108 in the direction of arrow 162. As such, a portion of ear portion 112 is positioned within cavity 128 defined by second portion 116 of temple portion 108 as ear portion 112 is slid towards first portion 114 of temple portion 108.

When desired, users can adjust the length of ear piece 106 by moving ear portion 112 inward and rotating latch 110 downward before ear piece 106 is in the collapsed position. In such a configuration, projections 156 of latch 110 are press-fit into grooves 144 to re-engage grooves 144 on ear portion 112 to hold ear portion 112 in the desired position and prevent movement of ear portion 112 relative to temple portion 108. That is, rotating latch 110 to re-engage extension portion 136 or ear portion 112 facilitates locking ear portion 112 in an intermediate position between the extended position and the collapsed position. As such, a user is able to adjust the length of ear piece 106 to correspond to their head size.

FIG. 7 illustrates ear piece 106 with ear portion 112 in the collapsed position. In the exemplary embodiment, grooves 144 of ear portion 112 slide along guides 134 of temple portion 108 until a portion of ear portion 112 is positioned within cavity 128 of temple portion 108 when ear portion 112 is in the collapsed position. More specifically, first end 158 and the majority of extension portion 136 are positioned within cavity 128 of first portion 114 of temple portion 108 when ear portion 112 is in the collapsed position. As such, first portion 114 completely surrounds extension portion 136 of ear portion 112 when ear portion 112 is in the collapsed position.

Furthermore, the U-shaped second portion 116 of temple portion 108 allows hook portion 138 of ear portion 112 to slide inward of temple portion second end 120 such that hook portion 138 is positioned between ends 118 and 120 of temple portion 108 when ear portion 112 is in the collapsed position. More specifically, hook portion 138 extends obliquely from within cavity 128 of temple portion 108 through an open section 164 (shown in FIG. 2B) of U-shaped second portion 116. As such, open section 164 enables telescopic movement of ear portion 112 within temple portion 108 between the extended and collapsed positions.

In the exemplary embodiment, once ear portion 112 is in the collapsed position, that it, once hook portion 138 has slid passed second end 120, latch 110 may be rotated in the direction of arrow 166 to re-align with temple and ear portions 108 and 112. In such a configuration, latch 110 is in the same position as when ear portion 112 is in the extended position and prevents non-intentional movement of ear portion 112 from the collapsed position to the extended position. More specifically, in the exemplary embodiment, latch projections 156 are slightly larger than grooves 144 and are press-fit into grooves 144 such that grooves 144 is not slidably coupled to latch 110. As such, projections 156 block the sliding movement of ear portion 112 along temple portion 108 and prevent ear portion 112 from moving from the collapsed position to the extended position when latch is rotated downward, as shown in FIG. 7. Alternatively, latch projections 156 are any size and latch 110 includes any configuration that prevent ear portion 112 from moving from the collapsed position to the extended position, as described herein.

The above-described embodiments of an eyeglass apparatus provide a telescopic ear piece that facilitates reducing the space required to store the eyeglass apparatus. Specifically, the eyeglass apparatus includes a pair of lenses, a frame coupled to the pair of lenses, and a pair of earpieces coupled to the frame. Each earpiece includes a temple portion coupled to the frame, a latch pivotally coupled to the temple portion, and an ear portion slidably coupled to the temple portion between an extended portion and a collapsed position. The latch is selectively coupled to the ear portion to enable movement of the ear portion between the extended position and the collapsed position. Furthermore, the temple portion defines a cavity that houses at least a portion of the ear portion when the ear portion is in the collapsed position. Moreover, a portion of the temple portion is U-shaped to enable telescopic engagement of the temple portion and the ear portion.

By housing the majority of the ear portion within the temple portion in the collapsed position, the eyeglass apparatus requires a smaller volume of space in which to store the eyeglasses than convention eyeglasses. The telescopic configuration makes efficient use of the space within the temple portion to provide for a compact storage configuration of the eyeglasses. Furthermore, because the ear portion is stored within the temple portion, the ear piece provides a structure that is more durable and less likely to be damaged when stored.

Exemplary embodiments of eyeglass apparatuses are not limited to the specific embodiments described herein, but rather, components of the apparatus may be utilized independently and separately from other components and/or steps described herein. For example, the methods may also be used in combination with other systems requiring telescoping assemblies and the associated methods, and are not limited to practice with only the eyeglass apparatus as described herein. Rather, the exemplary embodiment can be implemented and utilized in connection with many other applications, equipment, and systems that may benefit from telescoping assemblies.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An eyeglass apparatus comprising:
a pair of lenses;
a frame coupled to said pair of lenses; and
a pair of earpieces coupled to said frame, wherein each earpiece of said pair of ear pieces comprises:
a temple portion coupled to said frame, wherein said temple portion comprises a first portion that defines an enclosed cavity and a second portion that defines an open section; and
an ear portion slidably coupled to said temple portion between an extended position and a collapsed position, wherein at least a portion of said ear portion is positioned within said enclosed cavity of said first portion of said temple portion when said ear portion is in the collapsed position, and wherein the open section is defined such that at least a portion of said ear portion extends through the open section when said ear portion is in the collapsed portion.

2. The eyeglass apparatus in accordance with claim 1, wherein said first portion of said temple portion is coupled to said frame and said second portion of said temple portion is coupled to said ear portion.

3. The eyeglass apparatus in accordance with claim 1, wherein said ear portion comprises a hook portion configured to extend obliquely from within said cavity when said ear portion is in the collapsed position.

4. The eyeglass apparatus in accordance with claim 1, wherein said first portion comprises four walls and said second portion comprises only three walls.

5. The eyeglass apparatus in accordance with claim 1, wherein said ear portion comprises a hook portion, and wherein at least a portion of said hook portion is positioned between opposing ends of said temple portion when said ear portion is in the collapsed position.

6. The eyeglass apparatus in accordance with claim 1, wherein said temple portion comprises at least one guide and said ear portion comprises at least one groove configured to slidably engage said guide to facilitate movement of said ear portion between the extended position and the collapsed position.

7. The eyeglass apparatus in accordance with claim 1, wherein said ear portion is telescopically coupled to said temple portion.

8. The eyeglass apparatus in accordance with claim 1 further comprising a latch pivotally coupled to said temple portion and selectively coupled to said ear portion to enable movement of said ear portion between the extended position and the collapsed position.

9. The eyeglass apparatus in accordance with claim 8, wherein said latch comprises at least one projection configured to engage said ear portion in the extended position and in the collapsed position.

10. The eyeglass apparatus panel in accordance with claim 9, wherein said at least one projection is configured to disengage said ear portion to enable movement of said ear portion between the extended position and the collapsed position.

11. An eyeglass apparatus comprising:
a pair of lenses;
a frame coupled to said pair of lenses; and
a pair of earpieces coupled to said frame, wherein each earpiece comprises:
a temple portion coupled to said frame;
a latch rotatable around a pivot point at which said latch is pivotally coupled to said temple portion; and
an ear portion slidably coupled to said temple portion between an extended position and a collapsed position, wherein said latch is selectively coupled to said ear portion to enable movement of said ear portion between the extended position and the collapsed position.

12. The eyeglass apparatus in accordance with claim 11, wherein said temple portion comprises at least one guide and said ear portion comprises at least one groove configured to slidably engage said guide to facilitate movement of said ear portion between the extended position and the collapsed position.

13. The eyeglass apparatus in accordance with claim 12, wherein said latch comprises at least one projection configured to engage said at least one groove in the extended position and in the collapsed position, and wherein said at least one projection is configured to disengage said at least one groove to enable movement of said ear portion between the extended position and the collapsed position.

14. The eyeglass apparatus in accordance with claim 13, wherein said latch is configured to prevent movement of said ear portion from the collapsed position to the extended position.

15. The eyeglass apparatus in accordance with claim 11, wherein said latch is U-shaped.

16. The eyeglass apparatus in accordance with claim 11, wherein said temple portion comprises a first portion coupled to said frame and defining a cavity and a second portion coupled to said latch, wherein said first portion entirely encloses said cavity and said second portion is U-shaped.

17. The eyeglass apparatus in accordance with claim 16, wherein said ear portion comprises a hook portion configured to extend obliquely from within said cavity when said ear portion is in the collapsed position.

18. The eyeglass apparatus in accordance with claim 16, wherein at least a portion of said ear portion is positioned within said cavity when said ear portion is in the collapsed position.

19. The eyeglass apparatus in accordance with claim 11, wherein said ear portion is telescopically coupled to said temple portion.

20. The eyeglass apparatus in accordance with claim 11, wherein said latch comprises a pair of sidewalls, and wherein said ear portion is positioned between said pair of sidewalls in the extended position.

21. An eyeglass apparatus comprising:
a pair of lenses;
a frame coupled to said pair of lenses; and
a pair of earpieces coupled to said frame, wherein each earpiece of said pair of ear pieces comprises:
a temple portion coupled to said frame, wherein said temple portion comprises a first portion that defines an enclosed cavity and a second portion that is substantially U-shaped; and
an ear portion slidably coupled to said temple portion between an extended position and a collapsed position, wherein at least a portion of said ear portion is positioned within said enclosed cavity of said first portion of said temple portion when said ear portion is in the collapsed position, and wherein said second portion of said temple portion defines an open section such that at least a portion of said ear portion extends through the open section when said ear portion is in the collapsed portion.

22. The eyeglass apparatus in accordance with claim 21, wherein said ear portion comprises a hook portion configured to extend obliquely from within said cavity when said ear portion is in the collapsed position.

23. The eyeglass apparatus in accordance with claim 22, wherein said hook portion is configured to extend through the open section of said second portion of said temple portion when said ear portion is in the collapsed position.
